(19) United States
(12) Patent Application Publication
(10) Pub. No.: US 2015/0204485 A1
(43) Pub. Date: Jul. 23, 2015

(54) STATION AND METHOD FOR SUPPLYING A FLAMMABLE FLUID FUEL

(71) Applicant: Cryolor, Ennery (FR)

(72) Inventor: Lucien VARRASSI, Porcelette (FR)

(73) Assignee: L'Air Liquide, Societe Anonyme Pour I'Etude et I'Exploitation des Procedes Georges Claude

(21) Appl. No.: 14/601,470

(22) Filed: Jan. 21, 2015

(30) Foreign Application Priority Data
Jan. 21, 2014 (FR) 1450456

(51) Int. Cl. F17C 7/02; F17C 13/12; F17C 13/02

(52) U.S. Cl. CPC F17C 7/02; F17C 13/02; F17C 13/12

(57) ABSTRACT

A station for supplying a flammable fluid fuel, the station (1) comprising a first cryogenic tank (2) for storing flammable fuel in the form of a cryogenic liquid, a second cryogenic tank (3) for storing a non-flammable gas and notably an inert gas stored in the form of a cryogenic liquid, a cooling circuit (4, 14) in a heat-exchange relationship with the first tank (2), the cooling circuit (4, 14) comprising an upstream end connected to the second cryogenic tank (3) for drawing cryogenic fluid from the second cryogenic tank (3) in order to give up frigories from the fluid of the second cryogenic tank (3) to the first tank (2), the station comprising a circuit (4, 14, 7) for withdrawing fluid from the second tank (3), characterized in that the station comprises at least a detector (5) of fuel leaks from the first tank (2) and at least a controlled member (6, 11) for opening a portion of the withdrawing circuit (4, 14, 7), the at least one opening member (6) being controlled automatically in response to a detection of a leak by the at least one detector (5) in order to release fluid derived from the second cryogenic tank (3) so as to inert a volume within the station.

### CROSS REFERENCE TO RELATED APPLICATIONS

This application claims the benefit of priority under 35 U.S.C. §119 (a) and (b) to French Patent Application No. 1450456 filed Jan. 21, 2014, the entire contents of which are incorporated herein by reference.

### BACKGROUND

The present invention relates to a station for supplying a flammable fluid fuel and to a storage method.

### SUMMARY

The invention relates more particularly to a station for supplying a flammable fluid fuel, the station comprising a first cryogenic tank for storing flammable fuel in the form of a cryogenic liquid, a second cryogenic tank for storing a non-flammable gas and notably an inert gas stored in the form of a cryogenic liquid, a cooling circuit in a heat-exchange relationship with the first tank, the cooling circuit comprising an upstream end connected to the second cryogenic tank for drawing cryogenic fluid from the second cryogenic tank in order to give up frigories from the fluid of the second cryogenic tank to the first tank, the station comprising a circuit for withdrawing fluid from the second tank.

Storing a cryogenic liquid in an insulated tank under vacuum is prone to an increase in the internal pressure thereof. This is because if liquid is not regularly withdrawn, heat input from the tank supports, the piping and the insulation heat up the vacuum between the walls. Liquid vaporizes in the tank and as a result the pressure will increase until a safety valve opens.

Degassing of gases such as nitrogen, oxygen and argon does not present too much of a problem, but when the gas stored is a flammable gas (natural gas, hydrogen, etc.) such degassing carries the risk of creating an explosive cloud and therefore an “ATEX zone”.

One known solution is to condense part of the gaseous phase in the tank or to cool the liquid in order to prevent it from vaporizing (cf. document DE19903214).

In addition, in the event of a leak of flammable gas, the installation is also likely to cause an explosion.

Systems for avoiding the negative consequences of such leaks are generally complex, expensive and of average effectiveness.

It is an object of the present invention to alleviate all or some of the prior art disadvantages noted hereinabove.

To that end, the station according to the invention, in other respects in accordance with the generic definition given thereof in the above preamble, is essentially characterized in that it comprises at least a detector of fuel leaks from the first tank and at least a controlled member for opening a portion of the withdrawing circuit, the at least one opening member being controlled automatically in response to a detection of a leak by the at least one detector in order to release fluid derived from the second cryogenic tank so as to inert a volume within the station.

Moreover, some embodiments of the invention may comprise one or more of the following features:
the leak detector comprises at least one out of: a fuel sensor, a catalytic probe, a chemical sensor, a sensor of an optical type,
the at least one opening member comprises at least one out of: a cock, a valve, a spray nozzle,
the at least one opening member is spaced away from the first tank by a distance comprised between zero and five meters and preferably between zero and two meters,
the station contains a control cabinet that groups together the functional control members of the station, and the at least one opening member comprises an end that opens at least in part into the said cabinet,
the cooling circuit comprises at least one exchanger or coil housed inside the first tank,
the withdrawing circuit is connected to the cooling circuit and fed with fluid derived therefrom,
the station comprises two distinct opening members spaced apart,
the cooling circuit comprises two distinct pipes connected by an upstream end to the second tank and each provided with an exchanger or coil or condenser housed in the first tank, the two coils being situated respectively in the upper and lower parts of the first tank,
the station comprises two opening members respectively situated on two distinct portions of the withdrawing circuit and respectively connected to the two distinct pipes of the cooling circuit which are provided with the exchangers or coils,
the first and second tanks are double-walled cryogenic tanks with a vacuum between the walls,
the first and second tanks are housed in a common outer shell under vacuum.

The invention also relates to a method for storing a flammable fluid fuel in a filling station comprising a first cryogenic tank storing flammable fuel in the form of a cryogenic liquid, a second cryogenic tank storing an inert gas at a temperature lower than the temperature of the fluid contained in the first tank, the station comprising a cooling circuit in a heat-exchange relationship with the first tank, the cooling circuit having an upstream end connected to the second cryogenic tank, the method comprising a step of withdrawing cryogenic fluid from the second cryogenic tank, a step of exchanging heat between this withdrawn fluid and the fluid contained in the second cryogenic tank in order to reduce or eliminate the vaporization of the fluid in the first tank, the method comprising a step of detecting a potential leak of fluid from the first tank and, if such a leak is detected, a step of releasing fluid derived from the second tank into the atmosphere within the station adjacent to the first tank in order to prevent ignition by inerting.

According to other possible features:
the fluid contained in the first tank comprises at least one out of: natural gas, methane, hydrogen, and the fluid contained in the second tank comprises at least one of: nitrogen, argon,
the fluid released in the event of a leak of fluid from the first tank being detected comes from the fluid that has exchanged heat with the fluid of the second cryogenic tank.

The invention may also relate to any alternative method or device comprising any combination of the features listed above or below.

### BRIEF DESCRIPTION OF THE DRAWINGS

Other specifics and advantages will become apparent from reading the description hereinafter which is given with reference to the figures in which:

FIG. 1 depicts a schematic and partial view in cross section illustrating a first embodiment of a station for supplying fuel according to the invention,

FIG. 2 depicts a schematic and partial view in cross section illustrating a second embodiment of a station for supplying fuel according to the invention.

### DESCRIPTION OF PREFERRED EMBODIMENTS

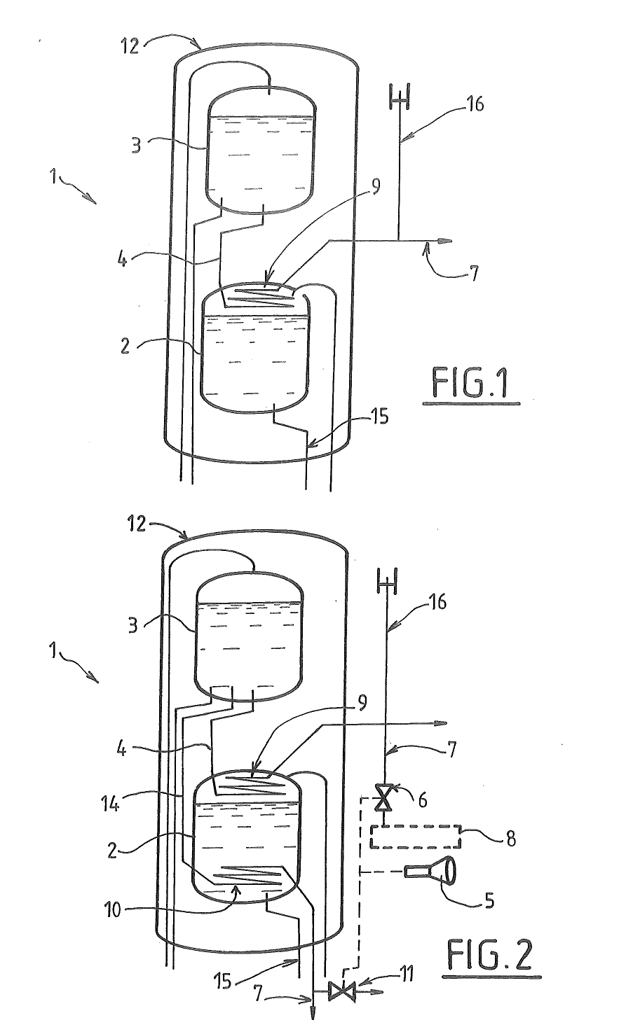

The station 1 illustrated in FIG. 1 is a station for supplying a flammable fluid fuel, for example natural gas, from a first cryogenic tank 2 storing the flammable fuel in the form of a cryogenic liquid (for example at −140° C.). More specifically, the first tank 2 contains a biphasic liquid/gas mixture.

The station 1 comprises a second cryogenic tank 3 for storing a non-flammable gas and notably an inert gas such as nitrogen stored at a temperature of −196° C.

The inert gas is also stored in the form of a cryogenic liquid (biphasic liquid/gas mixture).

The first 2 and second 3 tanks are preferably double-walled cryogenic tanks with a vacuum between the walls.

The station 1 comprises a circuit 15 for withdrawing fluid from the first tank 3. This circuit 15 comprises for example a pipe for supplying liquid fuel to a user, for example for filling vehicle tanks or volumes. Alternatively or in combination, the liquid withdrawn may be supplied to a vaporization unit in order to feed a user with gas.

The station 1 comprises a cooling circuit 4 in a heat-exchange relationship with the first tank 2 and notably with the fluid inside the first tank 2. The cooling circuit 4 comprises a pipe 4 having an upstream end connected to the second cryogenic tank 3 in order to draw cryogenic fluid from the second cryogenic tank 3. The cooling circuit 4 comprises, downstream, a portion 9 in a heat-exchange relationship with the inside of the first tank 1 so as to give up frigories from the fluid of the second cryogenic tank 3 to the first tank 2. This heat-exchange portion 9 comprises for example a coil, a condenser or any suitable type of exchanger.

Without thereby implying limitation, this exchanger 9 housed inside the first tank 2 is, for example, situated in the upper part of the first tank 2 to cool the gaseous part of the fuel. Downstream of this exchanger 9, the cooling circuit 4 may comprise a pipe 7 for supplying heated-up cooling fluid to a user (in gaseous and/or liquid form). Thus, the downstream part of the cooling circuit 4 may form a circuit 7 for withdrawing fluid from the second tank 3. What that means is that the withdrawing circuit 7 is connected to the cooling circuit 4 and fed with inert fluid derived therefrom. What that means is that the withdrawing circuit 7 supplies, downstream, fluid derived initially from the second tank 3 and which, upstream, has passed through the cooling circuit (4 and/or 14).

This withdrawing circuit 7 may comprise a stack 16 provided with a check valve that forms a vent if a determined overpressure is reached.

According to one advantageous feature, the station comprises at least one detector 5 of a leak of fuel from the first tank 2 and a controlled member 6, 11 for opening a portion of the cooling/withdrawing circuit 4, 7.

The leak detector 5 is preferably positioned in or adjacent to the station, for example at a distance comprised between zero and five meters away from the tanks 2, 3 or a control cabinet grouping together one or more of the valves of the station.

The opening member 6 is controlled automatically in response to a detection of a leak by the detector 5 to release fluid derived from the second cryogenic tank 3 so as to inert a volume within the station.

The at least one opening member 6 is situated on the cooling/withdrawing circuit downstream of the portion in a heat-exchange relationship with the first tank 2 and notably opens outside the tanks 2, 3. What that means is that the opening member 6 releases non-flammable gas from the second reservoir 3 that has exchanged heat (notably vaporized) with the first tank 2 into or around the station.

The leak detector 5 comprises for example at least one out of: a fuel sensor (notably a natural gas sensor), a catalytic probe, a chemical sensor, a sensor of an optical type, or any other suitable system.

The opening member 6 may comprise at least one out of: a cock, a valve, a spray nozzle or any other suitable device allowing inert gas to be released into a determined zone in response to the detection of a fuel leak.

For example, the opening member 6 is spaced away from the first tank 2 by a distance comprised between zero and five meters and preferably between zero and two meters, so as to inert the zone directly adjacent to the first tank 2. As an alternative, this opening member 6 is situated some distance away, in order to inert a more remote zone, for example between two and ten meters away if the leak is likely to occur there and constitutes an at-risk zone.

If the station comprises a control cabinet 8 grouping together the functional control members of the station (electronic control valves, displays, etc), the opening member 6 may have an end opening at least in part into the said cabinet 8 so as to protect it against fire.

As illustrated in FIG. 1, advantageously but non-essentially, the shells delimiting the storage volumes of the first 2 and second 3 tanks may be housed in a common external shell 12 under vacuum. What that means is that the first 2 and second 3 insulated tanks under vacuum containing respective fluids at distinct temperatures share the same external shell and the same vacuum between the walls.

FIG. 2 illustrates one possible alternative form of embodiment of the invention, which differs from that of FIG. 1 only in that the cooling circuit comprises two distinct pipes 4, 14 each one provided with an exchanger or coil 9, 10 or condenser housed in the first tank 2. In addition, the station comprises two distinct opening members 6, 11 spaced apart and respectively fed by the two pipes 4, 14. Elements identical to those previously described are denoted by the same numerical references and are not described a second time.

As illustrated, the two coils 9, 10 are preferably situated respectively in the upper and lower parts of the first tank 2 (in order respectively to exchange heat with the gaseous and liquid parts of the fluid).

The two pipes 4, 14 are connected to the second tank 3 for example by respective upstream ends (although as an alternative that may be a common end).

The two members 6, 11 can thus open into distinct or common zones of the station.

It will therefore be readily appreciated that while being of a simple and inexpensive structure, the station 1 allows the fuel tank cooling fluid to be used to good effect to keep the station safe in the event of a fuel leak. The station may be fixed or mobile (mounted on a vehicle or a trailer).

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

1. A station for supplying a flammable fluid fuel, the station comprising a first cryogenic tank for storing flammable fuel in the form of a cryogenic liquid, a second cryogenic tank for storing a non-flammable gas and notably an inert gas stored in the form of a cryogenic liquid, a cooling circuit in a heat-exchange relationship with the first tank, the cooling circuit comprising at least one upstream end connected to the second cryogenic tank for drawing cryogenic fluid from the second cryogenic tank in order to give up frigories from the fluid of the second cryogenic tank to the first tank, the station comprising a circuit for withdrawing fluid from the second tank, wherein the station comprises at least a detector of fuel leaks from the first tank and at least a controlled member for opening a portion of the withdrawing circuit, the at least one opening member being controlled automatically in response to a detection of a leak by the at least one detector in order to release fluid derived from the second cryogenic tank so as to inert a volume within the station, and in that the circuit for withdrawing fluid from the second tank is connected to the cooling circuit and fed with fluid derived therefrom.

2. The station of claim 1, wherein the leak detector comprises at least one out of a fuel sensor, a catalytic probe, a chemical sensor, a sensor of an optical type.

3. The station of claim 1, wherein the at least one opening member comprises at least one out of a cock, a valve, a spray nozzle.

4. The station of claim 1, wherein the at least one opening member is spaced away from the first tank by a distance comprised between zero and five meters and preferably between zero and two meters.

5. The station of claim 1, further comprising a control cabinet that groups together the functional control members of the station, and in that the at least one opening member comprises an end that opens at least in part into the said cabinet.

6. The station of claim 1, wherein the cooling circuit comprises at least one exchanger or coil housed inside the first tank.

7. The station of claim 1, further comprising two distinct opening members spaced apart.

8. The station of claim 1, wherein the cooling circuit comprises two distinct pipes connected by an upstream end to the second tank and each provided with an exchanger or coil or condenser housed in the first tank, the two coils being situated respectively in the upper and lower parts of the first tank.

9. The station of claim 8, further comprising two opening members respectively situated on two distinct portions of the withdrawing circuit and respectively connected to the two distinct pipes of the cooling circuit which are provided with the exchangers or coils.

10. The station of claim 1, wherein the first and second tanks are double-walled cryogenic tanks with a vacuum between the walls.

11. The station of claim 10, wherein the first and second tanks are housed in a common outer shell under vacuum.

12. A method for storing a flammable fluid fuel in a filling station comprising a first cryogenic tank storing flammable fuel in the form of a cryogenic liquid, a second cryogenic tank storing an inert gas at a temperature lower than the temperature of the fluid contained in the first tank, the station comprising a cooling circuit in a heat-exchange relationship with the first tank, the cooling circuit having an upstream end connected to the second cryogenic tank, the method comprising a step of withdrawing cryogenic fluid from the second cryogenic tank, a step of exchanging heat between this withdrawn fluid and the fluid contained in the second cryogenic tank in order to reduce or eliminate the vaporization of the fluid in the first tank, the method comprising a step of detecting a potential leak of fluid from the first tank and, if such a leak is detected, a step of releasing fluid derived from the second tank into the atmosphere within the station adjacent to the first tank in order to prevent ignition by inerting, and in that the circuit for withdrawing fluid from the second tank is connected to the cooling circuit and fed with fluid derived therefrom.

13. The method of claim 12, wherein the fluid contained in the first tank comprises at least one out of natural gas, methane, hydrogen, and in that the fluid contained in the second tank comprises at least one of nitrogen, argon.
